(19) United States
(12) Patent Application Publication
(10) Pub. No.: US 2026/0200225 A1
(43) Pub. Date: Jul. 16, 2026

(54) DELAMINATION OF USED SOLAR MODULE

(71) Applicant: SOLARCYCLE, Inc., Mesa, AZ (US)

(72) Inventors: Pablo RIBEIRO DIAS, Mesa, AZ (US); Priscila SILVA SILVEIRA CAMARGO, Mesa, AZ (US)

(21) Appl. No.: 19/565,359

(22) Filed: Mar. 12, 2026

Related U.S. Application Data
(63) Continuation of application No. 18/409,600, filed on Jan. 10, 2024, now Pat. No. 12,576,631.
(60) Provisional application No. 63/479,527, filed on Jan. 11, 2023.

(51) Int. Cl. B32B 43/00; B23B 35/00; B32B 9/04; B32B 15/082; B32B 17/06

(52) U.S. Cl. CPC B32B 43/006; B23B 35/00; B32B 9/045; B32B 15/082; B32B 17/061; B32B 2311/08; B32B 2311/12; B32B 2315/08; B32B 2329/06; B32B 2331/04; B32B 2383/00; B32B 2457/12; Y10S 156/922; Y10S 156/937; Y10T 156/1184; Y10T 156/1967

(57) ABSTRACT

Delamination of a solar module (for, e.g., purposes of recycling) may be achieved by applying a rotating member(s) against surface(s) of a used solar module. In certain embodiments, the rotating member may comprise a straight router bit, which may be applied under computer control. Successive application of rotating member(s) at different heights, may afford the collection of different materials. According to one particular embodiment, a rotating router bit may be applied first against a polymer backsheet, and then at a different height against other materials comprising metals and PV material such as crystalline silicon. Collection of resulting fractions produced by delamination at different heights, can produce material (e.g., metals, silicon) of relatively high purity and suitable for reuse.

### CROSS-REFERENCE TO RELATED APPLICATION

This application is a Continuation of and claims priority to U.S. patent application Ser. No. 18/409,600, filed on Jan. 10, 2024, issued as U.S. Pat. No. 12,576,631 on Mar. 17, 2026, which claims priority to U.S. Provisional Patent Application No. 63/479,527, filed Jan. 11, 2023 and incorporated by reference in its entirety herein for all purposes.

### BACKGROUND

As world population increases, the earth is subjected to escalating environmental stress. One form of stress is manifest in rising global temperatures attributable to the burning of fossil fuels in order to provide energy needs.

Alternative energy sources can provide power, while lessening the carbon dioxide burden on the planet. One important source of alternative energy is solar power.

Solar modules are complex manufactured items. They harness the sun's energy and convert it into a usable energy source for residential, commercial and utility-scale applications. As the climate has been significantly impacted by the use of fossil fuels over the past century, the need for alternative sources of energy like solar has taken on greater importance.

Another form of environmental stress imposed upon the earth, is the accumulation and disposal of waste products from human activity. Accordingly, rather than discarding a solar module at the end of its lifetime, it may be desirable to recycle material(s) from a solar module for reuse and thereby avoid deposition in a landfill.

### SUMMARY

In connection with solar module recycling, embodiments apply rotating member(s) against surface(s) of a used solar module to effect delamination. In certain embodiments, the rotating member may comprise a straight router bit, which may be applied under computer control. Successive application of rotating member(s) at different heights, may afford the collection of different materials. According to one particular embodiment, a rotating router bit may be applied first against a polymer backsheet, and then at a different height against other materials comprising metals and PV material such as crystalline silicon. Collection of resulting fractions produced by delamination at different heights, can produce material (e.g., metals, silicon) of relatively high purity and suitable for reuse.

### BRIEF DESCRIPTION OF THE DRAWINGS

FIG. 1 shows a cross-sectional view of a monofacial solar module according to an example.

FIG. 1A shows a simplified overhead view of the laminate of a solar module, lacking the frame and the top transparent sheet.

FIG. 2 is a simplified cross-sectional view showing a wire to cut through one or more layers.

FIG. 3 shows a simplified view of delamination according to one embodiment.

FIG. 4 shows an embodiment applying a rotating member first against the transparent cover sheet of a used solar module.

FIG. 5 shows a simplified view of the delamination according to a 2nd example.

FIG. 5A shows a straight router bit.

FIG. 6 shows a cutter for cylinder hinge.

### DESCRIPTION

Solar modules exist in a variety of types and architectures. Examples of such modules can include but are not limited to:
Monocrystalline Solar Panels (Mono-SI)
Polycrystalline Solar Panels (p-Si)
Amorphous Silicon Solar Panels (A-SI)
Cadmium telluride photovoltaics (CdTe)
Copper indium gallium selenide modules (CIGS)
Copper indium selenide modules (CIS)
Concentrated PV Cell (CVP)
Biohybrid Solar modules
Monofacial modules
Bifacial modules
Modules without encapsulant
Silicon heterojunction solar modules
tunnel oxide passivated contact solar modules (TOPCON)
passivated emitter and rear contact solar modules (PERC)
Tandem-junction Solar Panels
Perovskite-based Solar Panels
Glass-Backsheet Solar Panels
Glass-Glass Solar Panels
Building-Integrated Solar Panels
Polymer-Based Solar Panels
Solar Roof Tiles
Solar Roof Shingles

Solar modules can last decades, with some degradation in performance over a module's lifetime. Also, solar modules that have been deployed on residential rooftops and other commercial and utility-scale applications for a number of years, may be decommissioned for a variety of reasons.

For example, (residential, commercial, utility) users of solar panels may desire to exchange their modules for newer, higher performing modules in order to maximize the amount of energy obtained from a solar array.

As more solar modules reach the end of their useful lives and/or are relinquished by their owners, it is desirable to dispose of the panels in an environmentally-friendly and economically-feasible way. Alternatively, it may be desired to refurbish and reuse existing solar modules to prolong their lifetimes and reduce cost.

Once it is determined that a solar module is no longer useful to its owner, e.g.:
the module has reached the end of its current deployment due to non- or underperformance,
the module has been damaged in transit, or
for other (e.g., economic) reasons,
   in order to avoid discarding the module into a landfill, the module may either be recycled or refurbished and reused.

Accordingly, to determine whether a solar module should be recycled or refurbished and reused, embodiments may implement one or more of the following processes, alone or in various combinations and sequences.
cleaning;
inspection to determine reusability;
testing;
remove cabling;
remove frames surrounding the panel and/or junction boxes (either manually, or e.g., using an automated deframing machine).
transparent front layers and potentially other layers (e.g., the backsheet) may be removed using a delamination process.

Remaining layers (of, e.g., a laminate) may be shredded. Shredded materials can be separated using one or more processes in order to extract various possible reusable materials therefrom (e.g., valuable commodity metals such as silicon, silver, and/or copper).

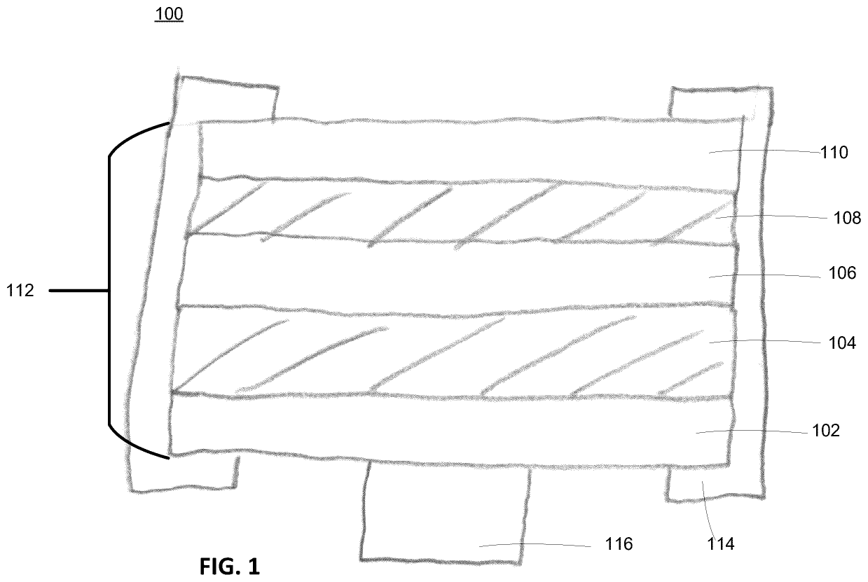

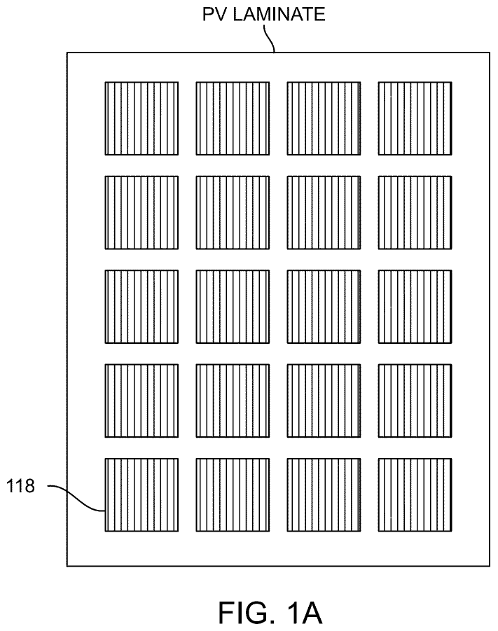

Embodiments relate to various techniques that may be employed, alone or in combination, for the recycling and/or refurbishment of solar modules. FIG. 1 shows a cross-sectional view of a monofacial solar module according to an example.

The PV module 100 is made of different layers assembled into the structure shown in FIG. 1. These layers of FIG. 1 are not drawn to scale.

The layers of FIG. 1 can be simplified as:
substrate (backsheet) 102,
back encapsulant 104, e.g., Ethylene-vinyl acetate (EVA), silicone, Polyvinyl butyral (PVB), IONOMER,
solar cell 106 comprising PV material (including, e.g., but not limited to: doped single crystal, polycrystalline, or amorphous silicon, Group III-V materials) and metallization,
front encapsulant 108,
transparent front cover sheet 110 (e.g., typically glass).
   This grouping of layers is referred to as a laminate 112.

It is further noted that bifacial modules also exist. Such bifacial modules may exhibit a structure similar to that of FIG. 1, but have a transparent (e.g., glass) layer instead of a backsheet layer. This allows (e.g., reflected) light to enter the module from the back.

The laminate in FIG. 1 is surrounded by a frame 114. The frame may comprise a stiff metal such as aluminum. Alternatively, a frame material may be plastic, comprising e.g., polycarbonate.

A junction box 116 is also part of the module. The junction box may be potted (more common in newer models) or non-potted (more common in older models). In a the potted PV junction box, the foils coming out of the solar panel are soldered to the diodes in the junction box, and the junction box is potted or filled with a type of sticky material to allow thermal transfer of heat to keep the solder joint in place and prevent it from falling. Fabrication may take longer but creates a better seal.

In the non-potted PV junction box, a clamping mechanism is used to attach the foil to the wires in the junction box. This can involve a faster assembly, but may not be as robust. A module having a potted junction box may be more amenable to recycling or refurbishment.

FIG. 1A shows a simplified overhead view of the laminate of a solar module, lacking the frame and the top transparent sheet. FIG. 1A shows solar cells including patterned metallization 118, which may comprise, e.g., a valuable metal such as silver.

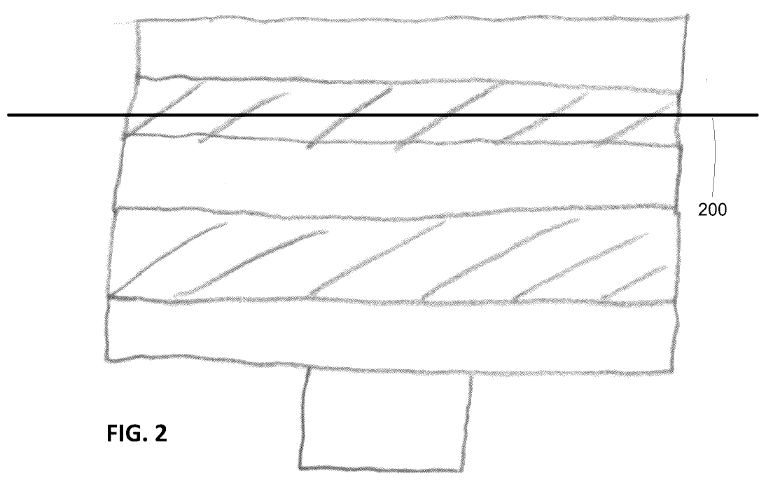

Prior to delamination, the frame is removed. Then, as shown in FIG. 2, according to embodiments a thin wire 200 may be used to cut through one or more layers (e.g., front encapsulant, back encapsulant, both front and back encapsulant, backsheet) of the PV laminate.

In some embodiments, the wire may be heated to temperatures of between about 400-600° C. For particular embodiments, this can be achieved by applying a difference of electric potential between the two ends of the wire.

The heated wire can then be pushed through encapsulant layer(s). This effectively separates the laminate into different parts.

According to some embodiments, the heat of the wire effectively degrades (“melts+burns”) the encapsulant. In certain embodiments, the wire physically cuts through the encapsulant material.

In particular embodiments, the wire may have a diameter of 0.5 mm or less. Specific embodiments may employ a wire having a diameter of between about 0.2-0.5 mm.

A wire material useful for embodiments, may exhibit high mechanical strength and sufficiently low electrical conductivity to generate the heat by resistive heating. Examples of possible candidates for wire materials include but are not limited to:
NiCr alloy,
stainless steel,
FeCrAl alloy,
aluminum (such as 6000 series),
copper coated materials.

Delamination according to particular embodiments, may separate the top (e.g., glass) sheet and the rest of the layers. For some embodiments, the delamination process could separate the laminate into three (3) distinct layers: the top sheet (e.g., glass), the solar cell, and the backsheet. For some embodiments, the delamination process could separate the laminate from the backsheet.

Embodiments may determine where pressure is specifically to be applied as part of a delamination process. For example, embodiments may determine a location as to where the wire should engage with the module.

One possible approach to targeting a location of application of the hot wire may be based upon optics. That is, differences in refraction index of cover sheet (e.g., glass) versus encapsulant (e.g., EVA) may be detected.

Another possible approach to wire targeting may be based upon X-Ray Diffraction (DRX). One example could detect an amorphous structure of a glass cover sheet, versus a semi-crystalline structure of EVA.

One possible approach to wire targeting, is to have the wire push against the glass as to create an angle between 5-45° from the panel inclination. Exerting a force down on the wire can serve to keep the panel flat during processing.

For some embodiments, data relating to factors including but not limited to:
panel size,
panel model, and/or
panel weight.
   could be stored in a database that is in turn referenced to output a thickness of the glass. The laminate could be aligned relating the model, manufacturer, and/or year to a database.

Use of a hot wire for delamination according to embodiments may offer one or more benefits. A first benefit is low energy use to heat up the wire. Another possible benefit is precise application of the wire to the laminate, resulting in clean separation of the layers.

Delamination efforts may employ approaches in alternative to, or in combination with, hot wire delamination. Particular embodiments may apply rotating member(s) against surface(s) of a used solar module to effect delamination. In certain embodiments, the rotating member may comprise a straight router bit, which may be applied under computer control. Successive application of rotating member(s) at different heights, may afford the collection of different materials. According to one particular embodiment, a rotating router bit may be applied first against a polymer backsheet, and then at a different height against other materials comprising metals and PV material such as crystalline silicon. Collection of resulting fractions produced by delamination at different heights, can produce material (e.g., metals, silicon) of relatively high purity and suitable for reuse.

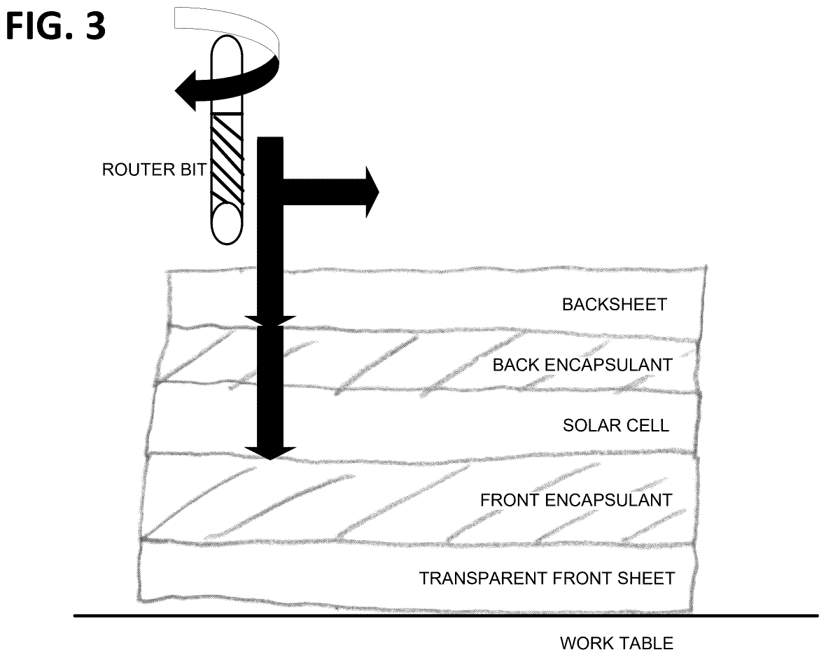

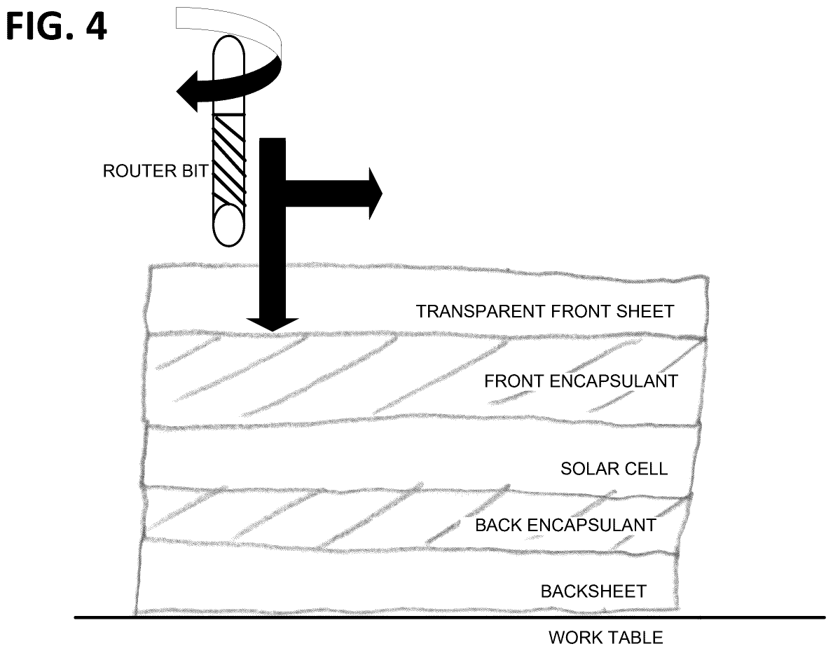

FIG. 3 shows a simplified view according to a specific embodiment. However, embodiments are not limited to this particular approach. For example, alternatives could instead apply a rotating member first against the transparent cover sheet of a used solar module. This is shown in FIG. 4.

### Example 1

The first example was performed automatically using a computer-controlled tool. In particular, the following materials were used for the first test:

| | |
|---|---|
| Workpiece | Cracked PV c-Si laminated with dimensions of |
| | 220 × 250 mm, from Komaes Solar |
| Tool | Computer numerical control (CNC) router of 3 |
| | axles, model Sigma 600 from Tecnodrill of Novo |
| | Hamburgo, Brazil |
| Tool Attachment | Set of clamps with “T” nuts, high hex nuts, step |
| | clamps, and step wedges |
| Tool Attachment | Straight router bit (8 mm) from Indaco |

The machining programming was performed in the Edgecam software, with the following parameters were applied:
machining area of 200×150 mm;
thinning function;
travel rate to the next roughing line with a lateral increment of 60% of the diameter;
horizontal milling cutter travel speed 800 mm/min;
vertical milling cutter travel speed 200 mm/min;
spindle rotation speed 5000 rpm;
the tip was lowered at every 0.1 mm to define the heights of each layer.

The clamping structure aligned the PV laminate surface, keeping the height uniform and allowing delamination of a laminate with cracked glass. The delamination heights were:
fraction #1: height=0.4 mm to remove the backsheet;
fraction #2: height=0.7 mm to remove the EVA;
fraction #3: height=1.1 mm to separate the silicon (in powder form) and the copper strips (in fragments), leaving the tempered glass.

In this first example, the use of CNC milling, and an 8 mm straight edge tip, allowed separation of these three layers. This enhanced the purity of the recovered materials, with few silicon losses.

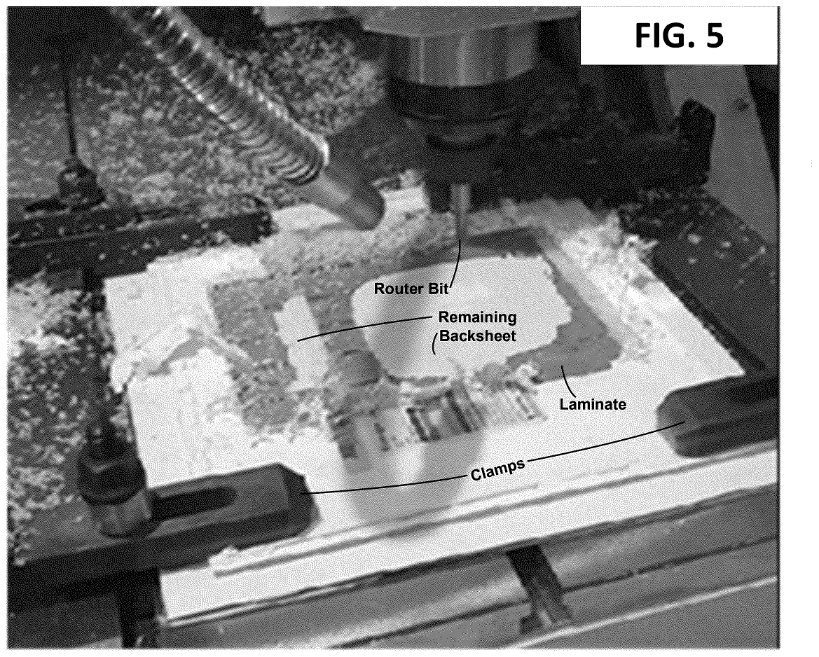

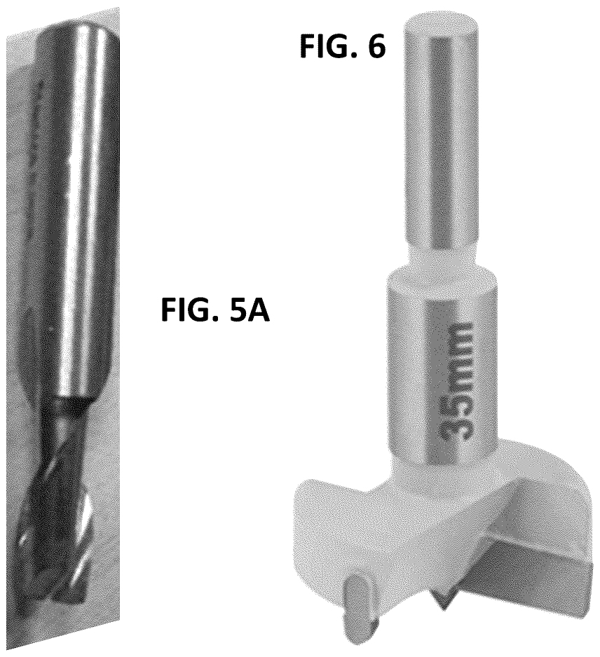

Automating fraction collection can enhance purity. FIG. 5 shows a simplified view of the delamination according to this second example. FIG. 5A shows the straight router bit.

### Example 2

This second example also used an automated approach, but with a different attachment. In particular, the following materials were used for the second test.

| | |
|---|---|
| Workpiece | New PV c-Si laminated with dimensions of |
| | 220 × 250 mm, from Komaes Solar |
| Tool | Computer numerical control (CNC) router of 3 |
| | axles, model Sigma 600 from Tecnodrill |
| Tool Attachment | Set of clamps with “T” nuts, high hex nuts, step |
| | clamps, and step wedges |
| Tool Attachment | Cutter for cylinder hinge, 35 mm diameter, with |
| | 2 teeth of widia, Vonder Vdo1631, available from |
| | the Widia Product Group |

Delamination heights obtained in the first example, were applied in this second example. The second example tested a router bit with a diameter larger than 8 mm to reduce operation time. However, the cutter for cylinder hinge with 35 mm diameter (FIG. 6) was of the cup saw type with 2 teeth. The center tip of the cutter tool was removed to have the same height at the cutting points.

The machining programming was performed in the Edgecam software, and the following parameters were applied:
machining area of 200×250 cm;
thinning function;
horizontal milling cutter travel speed 2000 mm/min;
spindle rotation speed 2000 rpm.

With the above parameters adopted, for this third example the removal time for each layer was 1 min and 7 sec, for a 20×25 cm area. This corresponded to a delamination speed of 17.9 min/m².

Embodiments are not limited to the particular examples described above. According to alternative embodiments, delamination could take place in whole or in part from the glass side (rather than, or in addition to, from the backsheet side).

Also, wire delamination could be used in combination with other delamination approaches as have been described herein.

A straight router bit having a diameter other than 8 mm (e.g., Example 1), could be employed alone or in combination with a cup saw type with teeth (e.g., Example 2).

It is also noted that the heights for each layer of material in a laminate may vary as the machining area increases. To reduce loss of silicon to a polymeric fraction, two layers may be removed:
(1) the backsheet with EVA, and
(2) silicon and copper ribbons (possibly including some EVA).

It is emphasized that the approaches as described above may be utilized alone, or in various combinations in order to effect the recycling and/or refurbishment of solar modules.

Embodiments may use multiple tips. Those tips can have different diameter sizes, and/or have surfaces that are straight or toothed.

Various types of equipment can be used for mechanical delamination. Examples include but are not limited to:
Computer Numerical Control (CNC) drill,
handheld drill,
wood grinder,
wood rectifier,
chisel,
non-automated drill.

In certain embodiments, a delamination system can be associated with suction system for debris or collection of material of interest, such as polymers, silicon, metals, glass. Such collected material could be in the form of powder or fragments.

For some embodiments, the collection of the delaminated material(s) can be accomplished done by suction. Electrical/electromagnetic properties and gravity can also be exploited. After collection, sieving systems can be employed in order to purify the material(s) of interest.

What is claimed is:

1. A method comprising:
applying an automated rotating bit at a first height against a first surface of a used solar module;
collecting a first fraction of material;
applying the automated rotating bit at a second height against the first surface of the used solar module; and then
collecting a second fraction of material.

2. A method as in claim 1 wherein the first surface comprises a backsheet.

3. A method as in claim 2 wherein the backsheet comprises a polymer.

4. A method as in claim 3 wherein the polymer comprises Ethylene-vinyl acetate (EVA), silicone, and/or Polyvinyl butyral (PVB).

5. A method as in claim 1 wherein the second fraction comprises crystalline silicon.

6. A method as in claim 1 wherein the second fraction comprises Cadmium.

7. A method as in claim 1 wherein the second fraction comprises perovskite.

8. A method as in claim 1 wherein the first surface comprises a transparent sheet.

9. A method as in claim 8 wherein the used solar module is bifacial and the transparent sheet is a back side.

10. A method as in claim 8 wherein the transparent sheet is glass.

11. A method as in claim 1 wherein the second fraction comprises metal.

12. A method as in claim 11 wherein the metal comprises silver.

13. A method as in claim 11 wherein the metal comprises copper.

14. A method as in claim 1 wherein the automated rotating bit comprises steel.

15. A method as in claim 1 wherein the automated rotating bit comprises diamond.

16. A method as in claim 1 wherein the automated rotating bit is under Computer Numerical Control (CNC).

17. A method as in claim 16 wherein applying the automated rotating bit to the first surface comprises milling.

18. A method as in claim 16 wherein the bit has a straight edge tip.

19. A method as in claim 16 further comprising:
applying the automated rotating bit at a third height against the first surface of the used solar module; and then
collecting a third fraction of material.

20. A method as in claim 19 wherein:
the first fraction comprises a first polymer;
the second fraction comprises a second polymer; and
the third fraction comprises silicon.
